(19) United States
(12) Patent Application Publication
(10) Pub. No.: US 2014/0158914 A1
(43) Pub. Date: Jun. 12, 2014

(54) OPTICAL COMPONENT WITH BLOCKING SURFACE AND METHOD THEREOF

(71) Applicants: Sandia Corporation, Albuquerque, NM (US); KLA-Tencor Corporation, Milpitas, CA (US)

(72) Inventors: Leonard E. Klebanoff, Dublin, CA (US); Jeromy T. Hollenshead, Albuquerque, NM (US); Gildardo Delgado, Livermore, CA (US); Elena Starodub, Sunnyvale, CA (US); Karl R. Umstadter, Livermore, CA (US); Guorong V. Zhuang, Santa Clara, CA (US); Garry Rose, Livermore, CA (US)

(21) Appl. No.: 14/101,065

(22) Filed: Dec. 9, 2013

Related U.S. Application Data
(60) Provisional application No. 61/735,967, filed on Dec. 11, 2012.

(51) Int. Cl. G02B 27/00; G01N 23/00

(52) U.S. Cl. CPC G02B 27/0006; G01N 23/00
USPC 250/492.2; 359/507; 359/350; 427/162; 427/553; 427/532

(57) ABSTRACT

An optical component arranged for use in a low pressure environment including: a surface arranged to receive extreme ultra-violet (EUV) light and a coating, on the surface, arranged to block at least one contaminant in the low pressure environment from binding to the surface. A method of mitigating contamination of a surface of an optical component, including: inserting the optical component into a chamber for a semi-conductor inspection system, controlling a temperature and a pressure within the chamber, introducing a blocking material, in a gaseous state, into the chamber, coating a surface of the optical component with the blocking material, and preventing, using the coating, a contaminant in the chamber from binding to the optical component.

### CROSS-REFERENCE TO RELATED APPLICATIONS

This application claims the benefit under 35 U.S.C. §119(e) of U.S. Provisional Patent Application No. 61/735,967, filed Dec. 11, 2012, which application is hereby incorporated herein by reference.

### STATEMENT REGARDING FEDERALLY SPONSORED RESEARCH OR DEVELOPMENT

This invention was made under a CRADA (SC11/01785.00) between KLA-Tencor and Sandia National Laboratories, operated for the United States Department of Energy. The Government has certain rights in this invention.

### TECHNICAL FIELD

The present disclosure relates to an optical component treated to prevent contamination of a surface of the component, a system including the component, and a method of coating an optical component with a contaminant-blocking surface. More particularly, the present disclosure relates to a surface of an optical component with a monolayer of atomic hydrogen or carbon-based molecules to prevent contaminants from adsorbing or diffusing onto the surface in a low pressure environment.

### BACKGROUND

FIG. 3 is a schematic side view of a prior art optical component showing possible routes of contamination. Extreme ultra-violent (EUV) light is used in semi-conductor inspection and lithography systems. EUV light is absorbable by most materials, thus the materials surrounding the EUV light, for example, optic components, are vulnerable to contamination by way of carbonization and/or oxidation. Photon induced reactions from the EUV light can interact with contaminants, such as hydrocarbons and water, surrounding the EUV optics. Unfortunately, it is practically impossible to eliminate these contaminants. For example, a carbonization reaction with hydrocarbons can produce adsorbed hydrocarbons, which can produce a contaminant layer. Surfaces of optic components can become contaminated by two different routes. The first route is by adsorption from the gas-phase. A second route of contamination is by surface diffusion by hydrocarbon species that have adsorbed onto hardware surrounding the optical components.

The two contamination routes described above can also occur when the semi-conductor inspection lithography system is vented to atmosphere for routine maintenance. In some cases, the venting atmosphere may be contaminated, or turbo pumps used in the venting have collected contaminants as the venting gas pass into the tool being vented. Alternatively, contaminant species may be stirred-up by the venting process, and inadvertently deposited onto component surfaces.

FIG. 3 shows a typical unprotected optical component 300. Contaminants C from contamination 310 and 320 create contaminant layer 303, which degrades the reflectivity of optical component 300. Contamination 310 refers to contaminants C, for example, hydrocarbons, in a residual vacuum, which tend to adsorb onto optical components from the gas-phase. Contamination 320 refers to contaminants C, for example, hydrocarbons, which tend to diffuse onto surface 302 from surrounding hardware 330, which is in contact with optical component 300.

Others have recognized this problem. It has been suggested that contamination can be reduced by simply reducing the residual water vapor and hydrocarbons present however, such a solution has proven to be very difficult, if not impossible, to achieve. U.S. Pat. No. 6,533,952 (Klebanoff et al.) describes a process for mitigating or eliminating contamination and/or degradation of surfaces having common, adventitious atmospheric contaminants adsorbed thereon and exposed to radiation. A gas or a mixture of gases is introduced into the environment of a surface to be protected. When the surface and associated bound species are exposed to radiation, reactive species are formed that react with surface contaminants such as carbon or oxide films to form volatile products (e.g., carbon monoxide and carbon dioxide) which desorb from the surface.

U.S. Pat. No. 6,770,776 (Klebanoff et al.) describes an apparatus that produces activated gaseous species adjacent a surface that is subject to carbon contamination such that in-situ cleaning of that surface is permitted.

### SUMMARY

According to aspects illustrated herein, there is provided an optical component arranged for use in a low pressure environment, including a surface arranged to receive extreme ultra-violet (EUV) light and a coating, on the surface, arranged to block at least one contaminant in the low pressure environment from binding to the surface.

According to aspects illustrated herein, there is provided a semi-conductor inspection system including a low pressure chamber, an inspection assembly in the low pressure chamber including an optical component with a surface arranged to receive extreme ultra-violet (EUV) light and a coating, on the surface, arranged to block a contaminant in the low pressure chamber from binding to the surface.

According to aspects illustrated herein, there is provided a method of mitigating contamination of a surface of an optical component, including: inserting the optical component into a chamber for a semi-conductor inspection system, controlling a temperature and a pressure within the chamber, introducing a blocking material, in a gaseous state, into the chamber, coating a surface of the optical component with the blocking material, and preventing, using the coating, a contaminant in the chamber from binding to the optical component.

According to aspects illustrated herein, there is provided a method of mitigating contamination of a surface of an optical component, including: inserting the optical component into a chamber, controlling a temperature and a pressure within the chamber, introducing molecular hydrogen into the chamber, disassociating the molecular hydrogen into hydrogen atoms, and coating a surface of the optical component with a monolayer of the hydrogen atoms. Substantially all of the orbitals for the hydrogen atoms are unavailable for bonding.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a schematic side view of an optical component with a contaminant-blocking coating;

FIG. 2 is a schematic block diagram of a semi-conductor inspection system including the optical component shown in FIG. 1; and,

FIG. 3 is a schematic side view of a prior art optical component showing possible routes of contamination.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure. The term “coating” is used interchangeably with the term “monolayer”. Additionally, the term “enclosed space” is used synonymously with the term “chamber”. The terms “material” and “elements” are used synonymously.

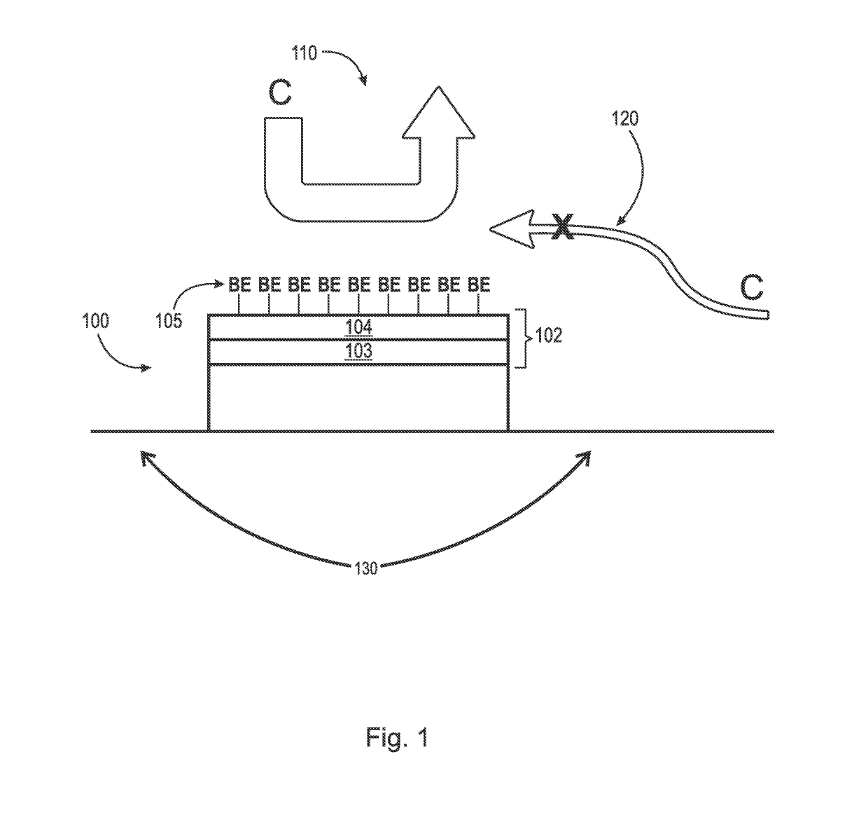

FIG. 1 is a schematic side view of optical component 100 with a contaminant-blocking coating. Optical component 100 includes surface 102 and contaminant-blocking coating 105. Optical component 100 is arranged for use in a low pressure environment and surface 102 is arranged to receive extreme ultra-violet (EUV) light in the low pressure environment, as further described below. Coating 105, on surface 102, is arranged to block at least one contaminant C, also shown as 110 and 120, in the low pressure environment from binding to surface 102. Optical component 100 can be any optical component known in the art, including, but not limited to a mask, a mirror, a silicon wafer, or a sensor.

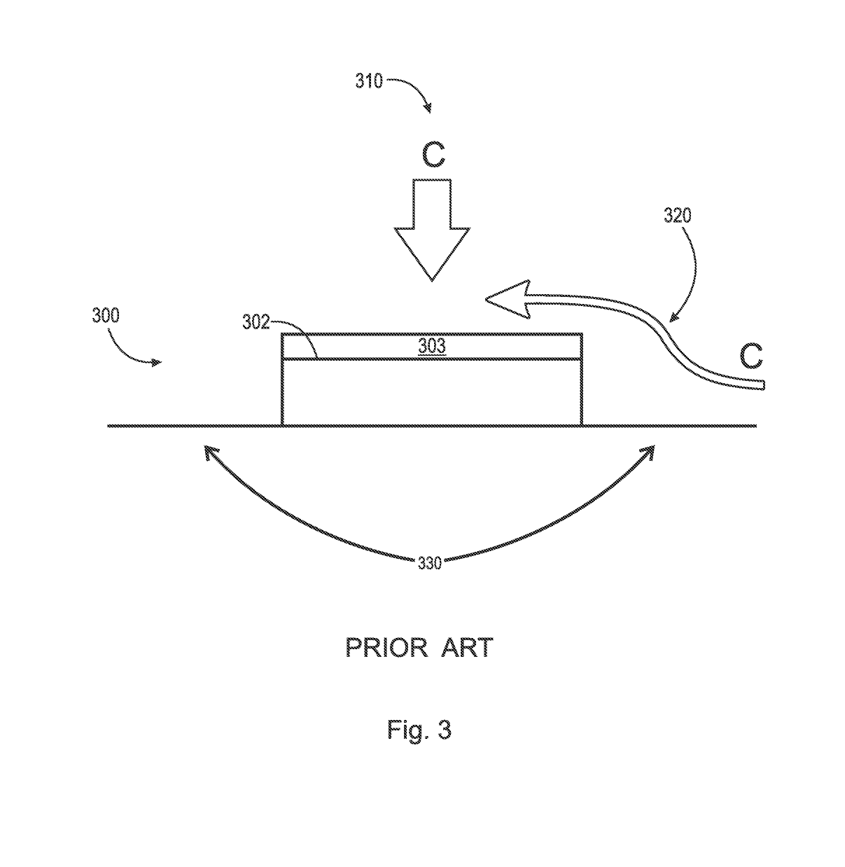

Layer 102 includes orbitals available for bonding. Thus, if contaminants C were to approach unprotected (uncoated) layer 102, the contaminants would be attracted to layer 102 and would strongly bond to layer 102, as is the case in FIG. 3. However, substantially all of the orbitals of coating 105 are unavailable for bonding. Thus, coating 105 resists strong bonds with contaminants, blocking the contaminants from binding to surface 102.

In an example embodiment, coating 105 is a layer of adsorbed hydrogen atoms one atom deep. In an example embodiment, surface 102 includes layer 103 of metal. In an example embodiment, surface 102 includes layer 104 of an oxide of the metal in layer 103. It should be appreciated that FIG. 1 is a schematic representation of how coating 105 monopolizes the surface sites of surface 102 to block contaminants C from binding to surface 102. Metal 103 can be any metal known in the art, for example, Ruthenium (Ru). In an example embodiment, BE is atomic hydrogen. Atomic hydrogen refers to isolated hydrogen atoms. Coating 105 with atomic hydrogen can be generated by introducing molecular hydrogen, meaning molecules of hydrogen or hydrogen atoms bound together, into the vicinity of component 100. The metal in layer 103 causes the hydrogen to disassociate into atomic hydrogen, which then bonds to surface 102 to form coating 105. Coating 105 is also referred to interchangeably herein as monolayer 105.

In an example embodiment, the formation of coating 105 is effected at cryogenic temperatures (˜150K). Hydrogen has a low EUV absorption such that the monolayer layer of hydrogen will not harm optical component 100.

In another example embodiment, coating 105 is formed of material having a low EUV absorption. Thus, coating 105 can include a layer of carbon monoxide one molecule deep, a layer of carbon dioxide one molecule deep, or a layer of TSurface CO₃⁻² anions one anion deep.

It should be appreciated that surface 102 of optical component 100 has an optical characteristic prior to application of coating 105 and the optical characteristic is not affected by coating 105. In an example embodiment, the optical characteristic is reflectivity of EUV light. However, it should be appreciated that the optical characteristic could be any optical characteristic known in the art, for example, diffraction, dispersion, polarization, or absorption.

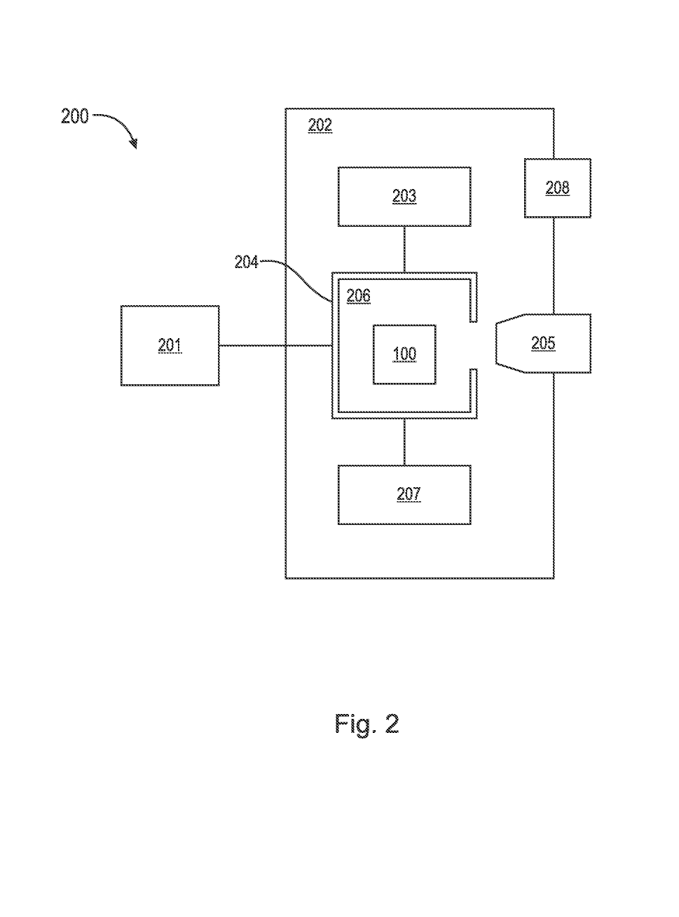

FIG. 2 is a schematic block diagram of semi-conductor inspection system 200 including optical component 100 shown in FIG. 1. The following should be viewed in light of FIGS. 1 and 2. Semi-conductor inspection system 200 includes extreme ultra-violet EUV light source 201 arranged to transmit light to inspection assembly 202, low pressure chamber 206, and inspection assembly 204 in low pressure chamber 206. Optical component 100 is located in assembly 204. The discussion of optical component 100 in FIG. 1 is applicable to system 200 except as noted. Coating 105 is arranged to block at least one contaminant in low pressure chamber 206 from binding to surface 102. With sufficient exposure to contaminants, blocking elements BE can become reactive; therefore, as further described below, blocking elements BE are maintained at a rate sufficient to continue to prevent contaminants C from absorbing to layer 102. In an example embodiment, inspection assembly 202 includes mask 203, inspector or wafer 207, and vacuum pump 205.

In an example embodiment, optical component 100 is fabricated by inserting optical component 100 having surface 102 into an enclosed space, such as chamber 206. Pressure and temperature are controlled within chamber 206 and blocking element (or material) BE, is introduced, in a gaseous state, into the chamber. As described above, element BE bonds with surface 102, forming coating 105. In an example embodiment, BE is molecular hydrogen. As noted above, coating 105 of atomic hydrogen is formed from the molecular hydrogen.

In an example embodiment, controlling the pressure includes maintaining a pressure of approximately 1 to 50 milliTorr in the chamber. However, it should be appreciated that any suitable pressure is applicable. In an example embodiment, controlling the temperature includes maintaining a temperature of between 288 and 308 degrees Kelvin. In an example embodiment, controlling the temperature includes maintaining cryogenic temperatures, for example, below 150 degrees Kelvin. However, it should be appreciated that the necessary temperature depends on blocking element BE of coating 105, for example, hydrogen, carbon monoxide, or carbon dioxide. Similarly, the necessary pressure also depends on blocking element BE of coating 105.

In an example embodiment, a layer of molecular hydrogen is maintained above surface 102, for example, to regenerate coating 105 as the atomic hydrogen forming coating 105 becomes reactive. For example, monolayer 105 is created and maintained at room temperature by keeping an elevated pressure (1-50 milliTorr) of BE, for example, hydrogen, above surface 102 during system operation to maintain a full monolayer 105 of hydrogen atoms on surface 102.

In an example embodiment, prior to venting system 200, system 200 is flushed briefly with hydrogen, for example, at elevated pressures (100-500 milliTorr) to further ensure the presence of monolayer 105 on surface 102 during the venting process during which contamination of surface 102 is more likely to occur. Further, flushing can be used to treat contaminated surfaces. In this manner, if surface 102 is contaminated, surface 102 can be flushed with purified carbon dioxide or carbon trioxide, followed by purified hydrogen. Carbon monoxide or other gases, such as, oxides (NxOy), are also suitable.

In example embodiment, chamber 206 is flushed with molecular hydrogen at a pressure of approximately 100 to 500 milliTorr and chamber 206 is then vented. When system 200 is vented, adsorbed hydrogen in coating 105 reduces the inadvertent contamination of the critical surfaces from contaminants C that may be in the venting gas, thereby preserving the optical integrity during the maintenance periods.

In an example embodiment, surface 102 is periodically dosed with blocking element BE to maintain coating 105. In an example embodiment, prior to introducing blocking element BE into chamber 206, metal oxide from surface 102 is removed using some or all of atomic hydrogen, molecular hydrogen, extreme ultra-violet light, and carbon monoxide.

In an example embodiment, optical component 100 is a multi-layer collector mirror (MLM) and helium (He) is introduced into the chamber 206 to prevent damage during operation and contamination during venting. In an example embodiment, the multi-layer collector mirror is biased and an electric field surrounding the multi-layer collector mirror is generated. In an example embodiment, the multi-layer collector is biased using an oscillating voltage.

In an example embodiment, surface 102 can be protected by exposing surface 102 to low energy helium ions and neutrals prior to use in EUV systems. It is beneficial to expose MLM surfaces to carbon monoxide, carbon trioxide, and helium prior to vacuum vents. The goal of these exposures is to prevent damage during operation and contamination during venting. The MLMs can be biased such that an electric field can be created between the MLM and the surrounding surfaces and incoming gas-phase species, thereby allowing for the effective energy of incoming ions to be increased. Biasing of these surfaces may also allow or prevent attachment of anion and/or cation species presented near the surface. Biasing of these surfaces by an oscillating voltage may be used to increase the desired effect.

In an example embodiment, surface 102 is dosed as needed with short bursts of carbon monoxide gas during tool operation, or briefly exposed to a flush of carbon monoxide prior to venting. After surface 102 is passivated by carbon monoxide, a monolayer 105 of carbon monoxide is formed without adversely affecting optical performance. Other gases can perform this function, for example, carbon dioxide, carbon trioxide, or polar molecules. When polar molecules are used, it is advantageous to place an opposite charge on surface 102 prior to venting.

Surface 102 can be preconditioned to enhance passivation. For example, on Ru surfaces one can use atomic hydrogen and EUV+H₂ to remove Ru oxides. Thus, starting with a virgin Ru surface will create enough surface sites to allow carbon monoxide passivation before venting. Carbon monoxide may passivate a clean Ru surface more completely than an oxide surface. In this case, it might be advantageous to precondition the Ru surface prior to carbon monoxide exposure. Similar arguments may apply for carbon or other contaminates on surface 102.

As noted above, carbon dioxide or carbon trioxide may be used as blocking element BE; carbon trioxide is known in the art to exist as anions when absorbed on alkali and transition metal surfaces. TSurface CO₃⁻² anions can act as surface blocking agents to prevent the absorption of contamination on the surface during venting, and as cleaning agent during system vacuum recovery after venting. An effective method of generating surface CO₃⁻² anions is to predose surface 102 (mirror capping layer could be material such as Ru but, the layer is not limited to Ru) with atomic oxygen followed by carbon dioxide. Other methods to generate CO₃⁻² anion could be CO+CO₂ co-venting and O₂+CO₂ co-venting.

Extreme EUV light of emerging inspection systems can involve MLMs made of Molybdenum/Silicon (Mo/Si). As is known in the art, MLMs are exposed to impinging fast ions, water, oxygen, contaminant species as well as impurities and debris leading to the degradation of optical system components. At moderate ion fluences (˜10¹⁴ Xe⁺/cm²), reflectivity loss occurs and very high fluences (>10¹⁷ Xe⁺/cm²) samples have shown signs of Xe blisters formation. Blistering has additionally been witnessed on Mo/Si multilayers as a result of irradiation by hydrogen species generated in a thermal capillary cracker. Blistering has also been attributed to oxygen, and water, or other contaminant species. Low-energy deuterium (D) plasma exposure on tungsten (W), which is an important material for fusion materials, results in blister formation on surface 102, for example, on MLMs. Blister formation increases both micron-sized dust production and D retention. Blister formation depends greatly on pretreatment of surface 102. Experiments have shown that a dramatic decrease in the retention properties of W when even a small amount of helium is present in the plasma. Proximate surface 102, helium filled nano-bubbles may act as a diffusion barrier to hydrogen isotopes. Helium may also reduce hydrogen isotope permeation.

It should be appreciated that a plurality of optical components is contemplated in a single system. Furthermore, it should be appreciated that optical component 100 does not experience over-doing of coating 105. Coating 105 includes molecules, for example, hydrogen or carbon monoxide that cannot grow as multilayers on an optic surface at room temperature. Advantageously, coating 105 is a monolayer to prevent the risk of over-dosing the optic component, which would harm reflectivity. Additionally, it should be appreciated that blocking element BE is introduced into the chamber via any suitable input mechanism 208.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. An optical component arranged for use in a low pressure environment, comprising:
a surface arranged to receive extreme ultra-violet (EUV) light; and,
a coating, on the surface, arranged to block at least one contaminant in the low pressure environment from binding to the surface.

2. The optical component recited in claim 1, wherein the coating is a layer of adsorbed hydrogen atoms one atom deep.

3. The optical component recited in claim 1, wherein substantially all of the orbitals for the coating are unavailable for bonding to other substances.

4. The optical component recited in claim 1, wherein the coating is selected from the group consisting of a layer of adsorbed carbon monoxide molecules one molecule deep, a layer of adsorbed carbon dioxide molecules one molecule deep, and a layer of TSurface CO₃⁻² anions one anion deep.

5. The optical component recited in claim 1, wherein the coating prevents the contaminant from:
adsorbing onto the surface; or,
diffusing onto the surface.

6. The optical component recited in claim 1, wherein:
the surface has an optical characteristic prior to application of the coating; and,
the optical characteristic is not affected by the coating.

7. The optical component recited in claim 1, wherein the surface includes a metal oxide.

8. The optical component recited in claim 1, wherein the optical component is selected from the group consisting of a mask, a mirror, a silicon wafer, and a sensor.

9. A semi-conductor inspection system, comprising:
a low pressure chamber;
an inspection assembly, in the low pressure chamber, including:
an optical component with:
a surface arranged to receive extreme ultra-violet (EUV) light; and,
a coating, on the surface, arranged to block a contaminant in the low pressure chamber from binding to the surface.

10. The system of claim 9, further comprising:
a plasma source arranged to generate the EUV light.

11. The system recited in claim 9, wherein substantially all of the orbitals for the coating are unavailable for bonding to other substances.

12. The system of claim 9, wherein the coating is a layer of adsorbed hydrogen atoms one atom deep.

13. The system of claim 9, wherein the coating is selected from the group consisting of a layer of adsorbed carbon monoxide molecules one molecule deep, a layer of adsorbed carbon dioxide molecules one molecule deep, and a layer of TSurface CO₃⁻² anions one anion deep.

14. The system of claim 9, wherein the coating prevents the contaminant from:
adsorbing onto the surface; or,
diffusing onto the surface.

15. The system of claim 9, wherein the optical component is selected from the group consisting of a mask, a mirror, a silicon wafer, and a sensor.

16. A method of mitigating contamination of a surface of an optical component, comprising:
inserting the optical component into a chamber for a semi-conductor inspection system;
controlling a temperature and a pressure within the chamber;
introducing a blocking material, in a gaseous state, into the chamber;
coating a surface of the optical component with the blocking material; and,
preventing, using the coating, a contaminant in the chamber from binding to the optical component.

17. The method recited in claim 16, wherein preventing the contaminant in the chamber from binding to the optical component includes preventing the contamination from:
adsorbing onto the surface; or,
diffusing onto the surface.

18. The method recited in claim 16, wherein preventing the contaminant in the chamber from binding to the optical component includes rendering substantially all of the orbitals for the coating unavailable for bonding to other substances.

19. The method recited in claim 16, wherein controlling the pressure includes maintaining a pressure of approximately 1 to 50 milliTorr in the chamber.

20. The method recited in claim 16, wherein controlling the temperature includes maintaining a temperature of between 288 and 308 degrees Kelvin in the chamber.

21. The method recited in claim 16, wherein introducing a blocking material includes introducing molecular hydrogen into the chamber.

22. The method recited in claim 21, wherein introducing molecular hydrogen into the chamber includes maintaining a layer of molecular hydrogen above the surface.

23. The method recited in claim 21, wherein:
the surface is formed of a metal oxide; and,
coating the surface of the optical component includes:
disassociating the molecular hydrogen into hydrogen atoms; and,
binding a layer of hydrogen atoms, one atom deep, onto the surface.

24. The method recited in claim 16, further comprising:
flushing the chamber with molecular hydrogen at a pressure of approximately 100 to 500 milliTorr; and,
venting the chamber.

25. The method recited in claim 16, wherein introducing the blocking material includes periodically dosing the surface with the blocking material.

26. The method recited in claim 16, wherein introducing the blocking material includes introducing a material selected from the group consisting of carbon monoxide, carbon dioxide, carbon trioxide, and polar molecules.

27. The method recited in claim 26, wherein the polar molecules have a first charge, the method further comprising:
applying a second charge, opposite the first charge, to the optical component.

28. The method recited in claim 16, wherein the surface is formed by a metal, the method further comprising:
prior to introducing the blocking element, removing metal oxide from the surface using some or all of atomic hydrogen, molecular hydrogen, extreme ultra-violet light, or carbon monoxide.

29. The method recited in claim 16, wherein:
the optical component is a multi-layer collector mirror; and,
introducing the blocking element includes introducing helium into the chamber.

30. The method recited in claim 29, further comprising:
biasing the multi-layer collector mirror; and,
generating an electric field surrounding the multi-layer collector mirror.

31. The method recited in claim 30, wherein biasing the multi-layer collector mirror includes biasing the multi-layer collector using an oscillating voltage.

32. A method of mitigating contamination of a surface of an optical component, comprising:
inserting the optical component into a chamber;
controlling a temperature and a pressure within the chamber;
introducing molecular hydrogen into the chamber;
disassociating the molecular hydrogen into hydrogen atoms; and,
coating a surface of the optical component with a monolayer of the hydrogen atoms, wherein substantially all of the orbitals for the hydrogen atoms are unavailable for bonding.

33. The method recited in claim 32, wherein introducing molecular hydrogen into the chamber includes maintaining a layer of molecular hydrogen above the surface.
